(19) United States
(12) Patent Application Publication
(10) Pub. No.: US 2018/0075479 A1
(43) Pub. Date: Mar. 15, 2018

(54) METHOD AND SYSTEM FOR PUBLICATION OF SOCIAL NETWORK MARKETING CONTENT BASED ON SCHEDULE AND PRIORITY

(71) Applicant: Making DeGraide Technology, LLC, Orlando, FL (US)

(72) Inventor: Adam D. DeGraide, Orlando, FL (US)

(73) Assignee: Making DeGraide Technology, LLC, Orlando, FL (US)

(21) Appl. No.: 15/353,095

(22) Filed: Nov. 16, 2016

Related U.S. Application Data
(60) Provisional application No. 62/394,827, filed on Sep. 15, 2016.

(51) Int. Cl. G06Q 30/02; H04L 12/58

(52) U.S. Cl. CPC G06Q 30/0251; G06Q 50/01; G06Q 30/0277; H04L 51/32

(57) ABSTRACT

A method and system for publishing social network content is disclosed. The method and system includes a computational device including a number of modules to effectuate timely publishing of social media content. A content module containing a plurality of content sorted into priority levels is provided. A filter module is configured to select content from the content module at predetermined intervals according to priority level assigned to the content is provided. A delivery module is configured to receive content from the filter module and populate a plurality of delivery slots of a schedule matrix is provided. Each delivery slot has a time and social network associated with it. A publication module is configured to publish content from the schedule matrix according to the time and social network designated for the content for each delivery slot.

### CROSS-REFERENCE TO RELATED APPLICATION

This patent document claims priority to earlier filed U.S. Provisional Patent Application No. 62/394,827, filed on Sep. 15, 2016, the entire contents of which are incorporated herein by reference.

### BACKGROUND

### 1. Technical Field

This patent document relates generally social media marketing and more particularly to a method and system for publication of social network marketing content based on schedule and priority.

### 2. Background of the Related Art

Social networks, such as Instagram, Facebook, Twitter, Pinterest and the like, have become an integral part of any modern marketing strategy. It is of vital importance that marketing content be specifically targeted with respect to content and time, that is, it is important that specific marketing content about specific topics be delivered to social networks at the correct time in order to maximize impact on revenue.

Therefore, there is a perceived need in the industry for a method and system for improving the targeting of marketing content on social networks.

### SUMMARY

The method and system described herein solves the problems of the prior art by providing a method system for publishing social network content, including a computational device having a content module containing content sorted into priority levels; a filter module configured to select content from the content module at predetermined intervals according to priority level assigned to the content; a delivery module configured to receive content from the filter module and populate a plurality of delivery slots of a schedule matrix, where each delivery slot has a time and social network associated therewith; and a publication module configure to publish content from the schedule matrix according to the time and social network designated for the content for each delivery slot.

### BRIEF DESCRIPTION OF THE DRAWINGS

These and other features, aspects, and advantages of the present invention will become better understood with reference to the following description, appended claims, and accompanying drawings where:

FIG. 1 shows an illustrated flow chart of an embodiment of the method and system for publication of social network marketing content;

FIG. 2 shows an alternative flow chart of the steps of an embodiment of the method and system for publication of social network marketing content; and

FIG. 3 shows an illustration of an embodiment of the method and system for publication of social network marketing content.

### DESCRIPTION OF THE PREFERRED EMBODIMENT

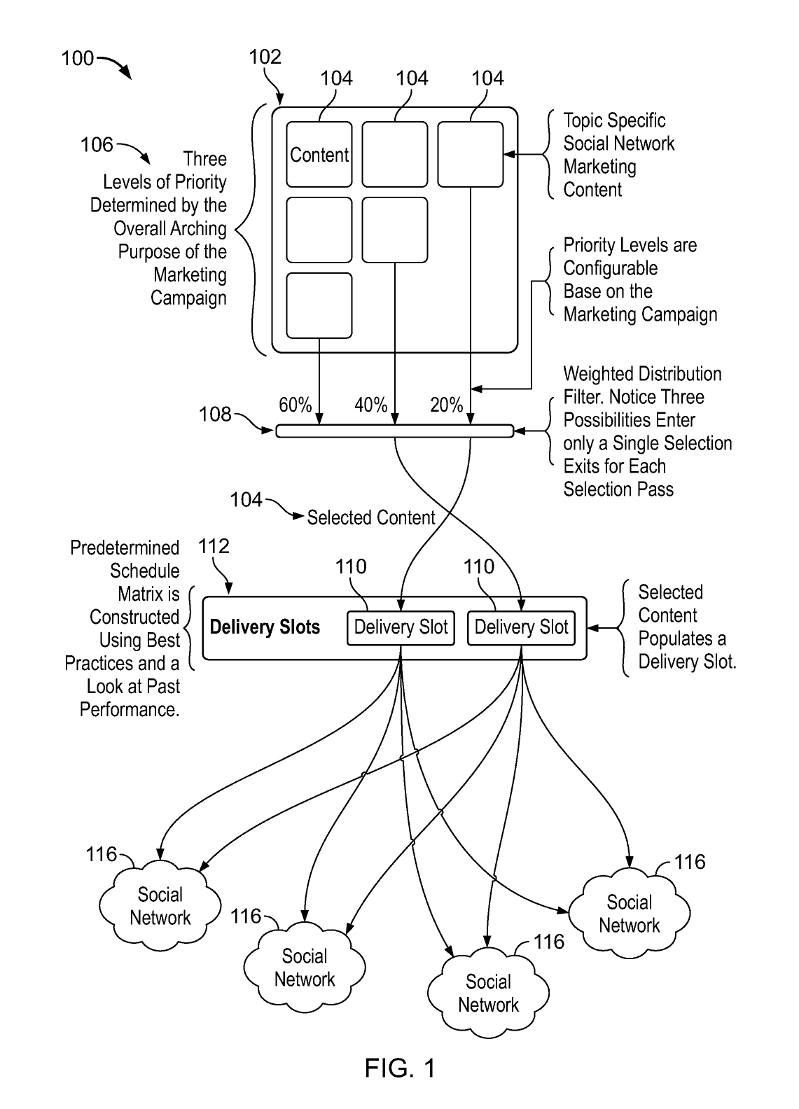

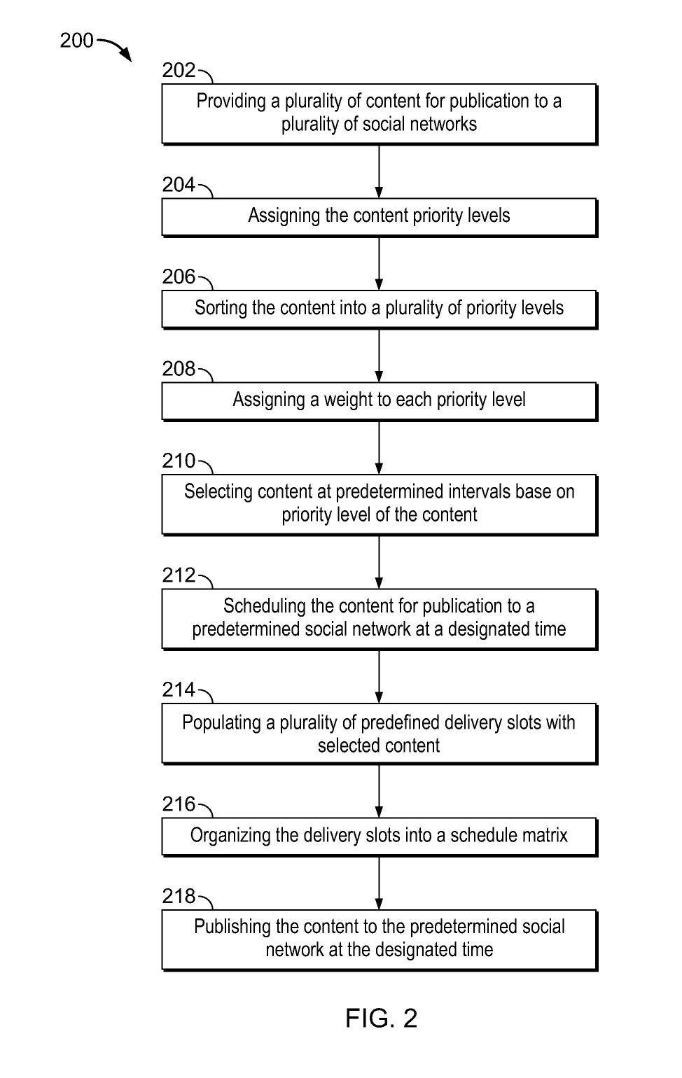

Referring now to FIG. 1, an embodiment of the system is illustrated generally at 100. The steps of the method employed by the system 100 are illustrated generally in FIG. 2. The method and system includes a content module 102 that contains content 104, such as topic specific social network marketing content, which are sorted into three levels of priority 106, determined by the overall purpose of the marketing campaign. The priority levels 106 define a frequency that content 104 of each level should be delivered. The priority level 106 may be user selected.

A filter module 108 includes a weighted distribution filter selects content at predetermined intervals, defined as a selection pass. Only a single selection of content 104 is allowed to pass the weighted distribution filter at each selection pass. The weighted distribution filter may be configured to allow a certain percentage of each priority level of content 196 to pass on each selection pass. For instance, Priority Level I content may have a 60% weight, Priority Level II content may have a 30% weight and Priority Level III content may have a 10% weight, as shown in FIG. 1. Other factors may be used.

A delivery module receives selected content 114 and populates delivery slots 110 in a predetermined delivery schedule matrix 112. The schedule matrix 112 is constructed using best practices, informed by past performance of content. Each delivery slot 110 includes an associated social network 116 and time the selected content 114 is desired to be published. At the predetermined time associated with the delivery slot 110, a publication module publishes the selected content to the associated social network.

Referring to FIG. 2, the method and system of publishing social network content, as described above in relation to FIG. 1, is shown illustrated as a series of steps at 200. In a first step 202, a plurality of content for publication to a plurality of social networks is provided. The content may be assigned priority levels in a step 204. The content is sorted into a plurality of priority levels in a next step 206. In a next step 208, the priority levels are assigned a weight. In a next step 210, the content is selected at predetermined intervals base on priority level of the content. In a next step 212, the content is scheduled for publication to a predetermined social network at a designated time. In a next step 214, a plurality of delivery slots is populated with the selected content. The delivery slots may be organized in a schedule matrix in a next step 216. In a next step 218, the content is published to the predetermined social network at the designated time. Although FIG. 2 depicts the step in a particular order, no particular order of the steps is intended and the claims should be read with the intent and breadth that the steps may occur out of sequence and repeat.

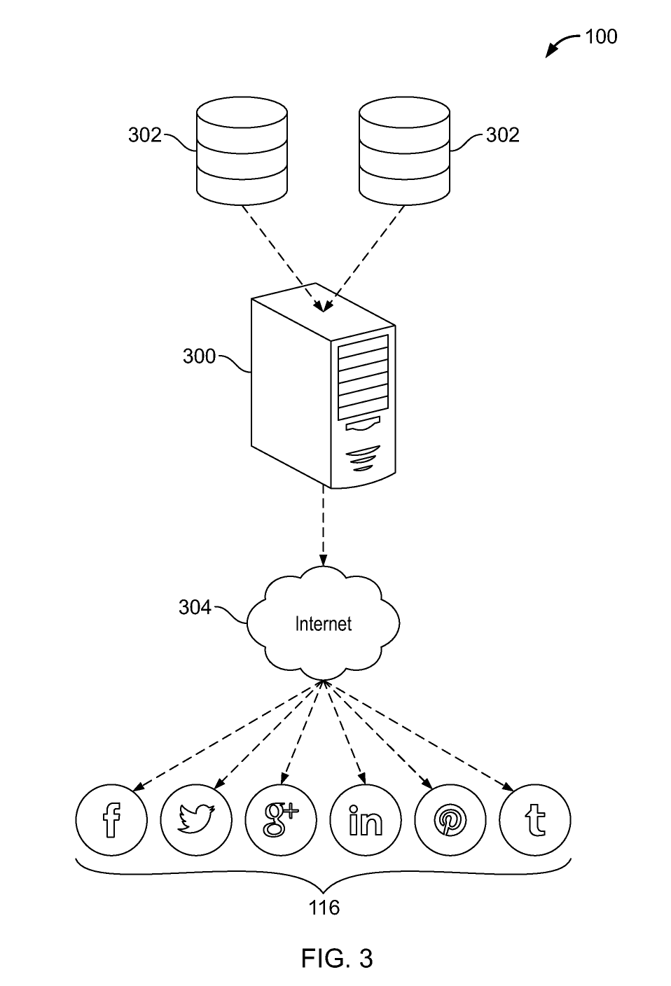

Referring to FIG. 3, the system 100 may be any arrangement known in the art that offers online computational functionality, including but not limited to a server or server arrangement 300, the Internet “cloud” 304, or other computational devices. The functionality called for herein in the aforementioned modules and steps may be executed over multiple devices forming the system and is not limited to a single device. Suitable computational devices, such as a server 300, typically include a processor, memory and storage, where the storage may be solid-state device or a hard disc. The computational devices also include a communication device, including a transmitter and receiver functionality configured to communicate with other computational devices in a network arrangement. The communication device may be wired or wireless, as is known in the art.

The system may call of the computational device to establish and maintain a specialized database or a specialized collection of databases 302. The database 302 may be configured to store content, priority levels of the content, properties and factors for the weighted distribution filter, the schedule matrix, including characteristics of the delivery slots, such as designated social network 116 and time and assigned content.

Therefore the method and system provides a distillation process for social network marketing content using weighted distribution to publish the social network marketing content based on the priority of a marketing campaign's target topic or topics. Topics with a higher priority will appear with greater frequency. Conversely, topics of less priority will appear with a lower frequency, allowing marketers to describe a comprehensive marketing strategy across topics. Moreover, the time content is displayed is also controlled, affording the campaign a higher degree of accuracy with respect to specific marketing targets.

It would be appreciated by those skilled in the art that various changes and modifications can be made to the illustrated embodiments without departing from the spirit of the present invention. All such modifications and changes are intended to be within the scope of the present invention.

What is claimed is:

1. A system for publishing social network content, comprising:
a computational device comprising:
a content module containing a plurality of content sorted into priority levels;
a filter module configured to select content from the content module at predetermined intervals according to priority level assigned to the content;
a delivery module configured to receive content from the filter module and populate a plurality of delivery slots of a schedule matrix, each delivery slot having a time and social network associated therewith; and
a publication module configured to publish content from the schedule matrix according to the time and social network designated for the content for each delivery slot.

2. The system of claim 1, wherein there are three priority levels, each priority level having a weighting factor associated therewith.

3. The system of claim 2, wherein the weighting factor is a percentage weight of the content.

4. The system of claim 1, wherein delivery module is further configured to populate the delivery slots of the schedule matrix factoring in past performance of previously delivered content.

5. The system of claim 1, wherein the filter module is further configured and arranged to select content at predetermined intervals during a selection pass, where only single selection of content is allowed to pass the filter module according to the weighted priority levels.

6. The system of claim 1, wherein the priority level of the content is user selected.

7. The system of claim 1, wherein the social networking content conforms to a predetermined marketing campaign.

8. A method of publishing social network content, comprising:
providing a plurality of content for publication to a plurality of social networks;
sorting the content into a plurality of priority levels;
selecting content at predetermined intervals base on priority level of the content;
scheduling the content for publication to a predetermined social network at a designated time; and
publishing the content to the predetermined social network at the designated time.

9. The method of claim 1, further comprising assigning the content priority levels.

10. The method of claim 9, wherein the step of assigning the content priority levels is user determined.

11. The method of claim 1, further comprising assigning a weight to each priority level.

12. The method of claim 11, wherein the assigned weight is determined by selecting a percentage of content of each priority level to publish.

13. The method of claim 1, wherein the step of scheduling the content includes populating a plurality of predefined delivery slots with selected content.

14. The method claim 1, wherein the step of scheduling the content includes factoring in past performance of previously delivered content.

15. The method of claim 1, wherein the step of scheduling the content includes organizing the delivery slots into a schedule matrix.
